(19) United States
(12) Patent Application Publication
(10) Pub. No.: US 2022/0215755 A1
(43) Pub. Date: Jul. 7, 2022

(54) Geolocation Based Vehicle Access Systems And Methods

(71) Applicant: Ford Global Technologies, LLC, Dearborn, MI (US)

(72) Inventors: Andrea Broaddus, Berkeley, CA (US); Jon Coleman, Saline, MI (US); Dhanush Harihar, Novi, MI (US); James Fishelson, Yosilanti, MI (US); Richard Twumasi-Boakye, Taylor, MI (US); Xiaolin Cai, Ann Arbor, MI (US); Mohammed Fayaj navaz, Dearborn, MI (US); Archak Mittal, Canton, MI (US); Amit Bhagwan, Dearborn, MI (US)

(73) Assignee: Ford Global Technologies, LLC, Dearborn, MI (US)

(21) Appl. No.: 17/143,441

(22) Filed: Jan. 7, 2021

(51) Int. Cl. G08G 1/14; H04W 4/021; G07C 5/00; G08G 1/017

(52) U.S. Cl. CPC G08G 1/149; H04W 4/021; G08G 1/017; G07C 5/008; G08G 1/148

(57) ABSTRACT

Geolocation based vehicle access systems and methods are disclosed herein. An example method includes receiving a blockchain ledger from a vehicle operating in a controlled area, the blockchain ledger including time-stamped, location and vehicle data. The method also includes comparing the time-stamped, location and vehicle data to database records that have control access parameters for controlled areas. In addition, the method includes generating a notice when the time-stamped, location and vehicle data matches control access parameters for the controlled area, which is one of the controlled areas. More so, the method includes providing the notice to the vehicle or a user of the vehicle.

### BACKGROUND

One of the functions of city government is controlling the public right-of-way in public spaces. Public space may become congested and increasingly subject to competition for use of such space. As a result, cities may desire to manage vehicle access to infrastructure in multiple realms. For example, a macro-realm control can involve controlling access to a city center or other high-demand areas (e.g., cordon pricing). An example of a meso-realm control can involve controlling access to a given lane or access during specific times of day (e.g., bus lanes). An example of a micro-realm control can involve controlling access to curbs, alleys, or prioritized parking—just to name a few.

Cities may also wish to constrain vehicle access based on other criteria that can include, but are not limited to, vehicle occupancy (e.g., HOV (high occupancy vehicle) lanes, disabled permit holder, and so forth) and vehicle powertrain (e.g., low emission zones). Some systems that have been developed for this purpose may entail the installation of external sensor or camera networks, which can be expensive, hard to scale, result in significant maintenance, and may be difficult to change once installed.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an illustrative architecture in which techniques and structures for providing the systems and methods disclosed herein may be implemented.

FIG. 2 is a flowchart of a method of the present disclosure.

FIG. 3 is a flowchart of a method of the present disclosure performed by a connected vehicle and/or a service provider.

FIG. 4 is a flowchart of a method of the present disclosure performed by a service provider and/or a connected vehicle.

### DETAILED DESCRIPTION

### Overview

The present disclosure is generally directed to geolocation based vehicle access systems and methods which are easily scalable and adaptable. The systems and methods may or may not rely on external sensor system(s) and may allow for access control at various scales. These systems and methods may also enable effective regulation and enforcement of control access policies related to public and/or private locations.

In certain embodiments, a vehicle-based geolocation system is disclosed that does not require (but can be used in conjunction with) additional external sensors (e.g. pole-mounted cameras, pavement pucks, and the like). Because the systems and methods disclosed herein do not require external sensors (e.g., infrastructure sensors), it is easily scalable. In this manner, these systems and methods disclosed herein can leverage existing technologies, which can be deployed at scale, and are configured to capture data that can be created through normal vehicle operations, such as GPS location data.

Some implementations can utilize a VIN (vehicle identification number), which can be used as a unique identifier for a vehicle (other details like its size, GVW (gross vehicle weight), and similar metrics) and license to operate can be included with VIN). Vehicles configured in accordance with the present disclosure can be equipped with a modem (or other equivalent unit, also referred to as a reporting module) enabling geolocation either as original equipment or aftermarket.

A city (e.g., its infrastructure management team) can define a ruleset for access control with respect to access parameters, such as location, time of day, license permission, occupancy, powertrain, or combinations thereof—just to name a few. For example, GPS (global positioning system) coordinates can be established for a specific area (e.g., geo-fenced portion) of the city during business hours.

When an equipped vehicle enters a controlled area, a system can create a digital geo-time stamp capturing the data, such as VIN, location, and time, along with any other data specified by the regulating entity. Equipped vehicles can utilize the system to record these geo-time stamps and upload them to a blockchain ledger via an API (application programming interface). The system can reconcile the reported geo-time stamps against the city's catalog of regulated areas and times and bill the users or identify non-compliant vehicles for enforcement actions.

### Illustrative Embodiments

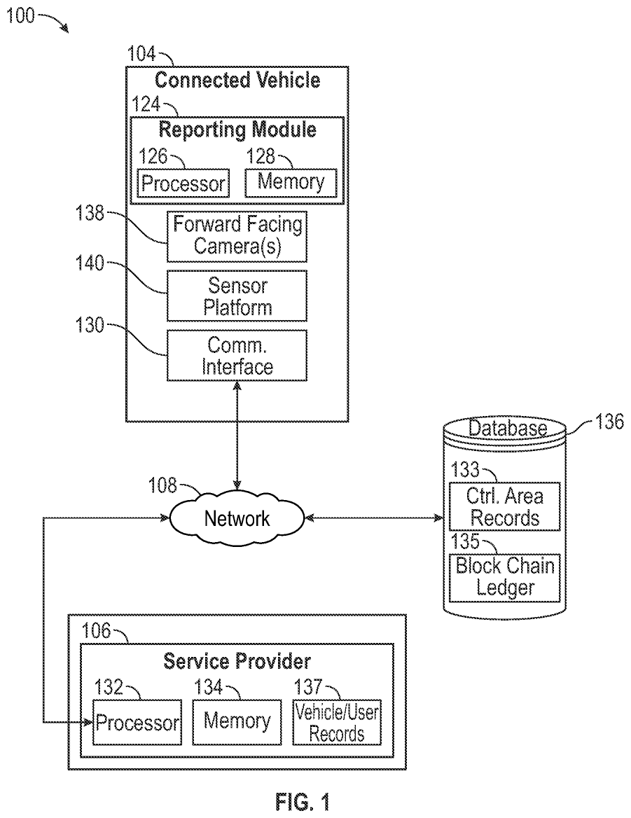

Turning now to the drawings, FIG. 1 depicts an illustrative architecture 100 in which techniques and structures of the present disclosure may be implemented. The architecture 100 can include a controlled area 102, one or more connected vehicles, such as connected vehicle 104, a service provider 106, and a network 108. It will be understood that the controlled area 102 illustrated in FIG. 1 is provided for illustrative and descriptive purposes and is not intended to be limiting.

The controlled area 102 may include an area within a city. For example, the area can include a curb area 110 that is frequently utilized. In this example, the city desires to manage or control access to the curb area 110. The connected vehicle 104 can occupy a portion of the curb area 110 to allow a user 112 to load and unload packages as an example. The curb area 110 can include three slots, such as slots 114, 116, and 118. The connected vehicle 104 is using slot 116. Another vehicle 120 is approaching slot 114 from a multilane road 122.

The connected vehicle 104 can include reporting module 124 that comprises a processor 126 and memory 128. The memory 128 stores instructions that can be executed by the processor 126 to perform functions in accordance with the disclosures provided herein, such as geo-locating, time-stamping, vehicle operation data capturing and analyzing, and blockchain ledger use. The reporting module 124 can include a communications interface 130 that allows the reporting module 124 to transmit data onto the network 108. As the connected vehicle 104 operates in the controlled area 102, the reporting module 124 collects location data, time-stamps the location data, and then adds the time-stamped, location and vehicle data to a blockchain ledger. The reporting module 124 can collect location and vehicle data and time-stamp it to create a data blockchain. The communications interface 130 can be used to connect to the network 108 and transmit the data blockchain to the service provider 106 and/or directly to the blockchain ledger 135.

The service provider 106 can also include a processor 132 and memory 134. The memory 134 stores instructions that can be executed by the processor 132 to perform functions in accordance with the disclosures provided herein, such as controlled area management, blockchain management, and compliance management. In general, the service provider 106 can receive the blockchain ledger and compare the time-stamped, location and vehicle data in a blockchain ledger 135 to a database 136 of controlled areas. Controlled area records 133 can be stored in the database 136.

The service provider 106 can also maintain vehicle/user records 137 for users of the system, such as a driver of the connected vehicle 104. The record of a user can include contact information that allows the service provider 106 to transmit notices to the user related to the user's use or interaction with a controlled area. A record can be tied to a unique identifier for the user or vehicle such as a VIN, but other unique data can be utilized. The vehicle/user records 137 can be stored at the service provider level 106 as well.

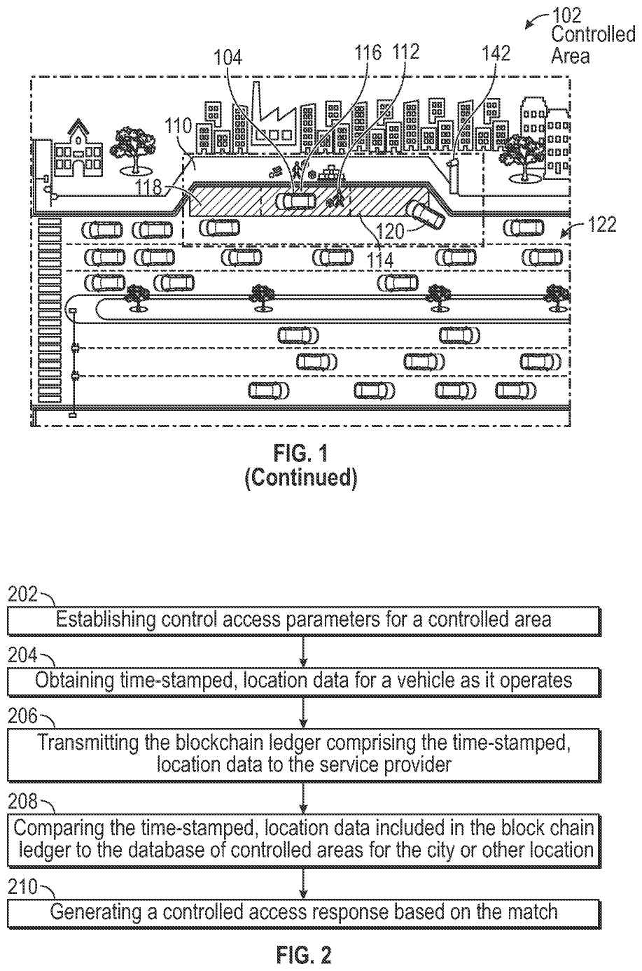

Referring now to FIG. 2, a process for utilizing the example architecture of FIG. 1 illustrates how a user, such as a city planner or administrator, defining one or more controlled areas in a city. The controlled area could include a curb, a portion of a sidewalk, a portion of a road, a parking lot, a garage, or any other location where the city desires to control access. The control of access can include any aspect parameters such as location, timing, cost, vehicle characteristics/attributes, and so forth. For example, the city can set forth regulations that control how long a user can occupy a space of a parking lot. Thus, the city can set forth the location (space and lot), a timing restriction (can be used from 8:00 am to 6:00 μm, and/or the space can be occupied for one hour increments of time), and cost (the space can be occupied for $10.00 per hour). Again, this is only an example and the parameters that define a controlled area can be fewer or greater in number and have values that correspond to the particular type of controlled area. For example, a loading zone in front of a building may have different parameters than a long or short-term parking lot in front of an arena. Thus, the method includes a step 202 of establishing control access parameters for a controlled area. As noted above, the control access parameters define how the controlled area can be utilized.

To utilize the systems and methods herein, a connected vehicle can utilize a reporting module as described above (see reporting module 124, FIG. 1). In more detail, as the vehicle operates in a location, such as a city, the vehicle can visit a controlled area, such as a curb or parking spot. As the vehicle operates, the reporting module can obtain location data (e.g., GPS coordinates) of the vehicle. The location data can be time-stamped. Thus, the method can include a step 204 of obtaining time-stamped, location and vehicle data for a vehicle as it operates. This process can be a continual process whereby the reporting module continually obtains (on a real-time and/or scheduled basis). The time-stamped, location and vehicle data can be stored as a blockchain ledger entry. That is, as the vehicle operates, the time-stamped, location and vehicle data that are collected are continually added to a blockchain ledger blockchain ledger. As noted above, other data that are indicative of the user or the vehicle can be added as well such as VIN, make, model, color, driver license number, address, and the like—just to name a few.

The method can include a step 206 of transmitting the blockchain ledger comprising the time-stamped, location and vehicle data to the service provider. The method can also include a step 208 of comparing the time-stamped, location and vehicle data included in the blockchain ledger to the database of controlled areas for the city or other location. When a match is determined based on the comparison, the method can include a step 210 of generating a controlled access response based on the match. For example, the controlled access response can include a notice related to a curb access fee, a rental fee, parking fee, or other similar communication. The service provider can manage notifications and assess penalties for non-payment or inaction, if appropriate. The service provider can disable use of the controlled access features of the system based on non-payment.

In one example use case, a city defines a curb (controlled area) by use (pick up/drop off, goods vehicles, time of day, handicap accessible, and so forth) by GPS coordinate zones. As vehicles visit the curb, a GPS record with time stamp is created by the vehicle. These data are processed at the service provider level to assess curb fees based on regulatory framework and alerts the owner either immediately or according to a scheduled time. The vehicle owner pays the curb access fees for the vehicle (or fleet of vehicles). If a vehicle is non-compliant (e.g. parked during rush hour), the service provider can identify appropriate (and sometimes real-time) enforcement actions such as fines, booting, towing, and the like.

Other example, use cases include, but are not limited to, cordon access, which is similar to the curb access example but used simply to identify geo-time stamp when a vehicle enters/exits a given geo-zone. A low emissions zone can be defined that allows a city to impose a regulation based on powertrain in operation within a controlled zone (e.g. electric only in city center). A High Occupancy Vehicle (HOV) zone can be provided access based on vehicle occupancy. A digital hangtag can be enabled that will grant a user of a disabled permit or other temporary license infrastructure access permission based on VIN and geolocation. Each of these use cases may involve including addition types of data being included in the blockchain ledger.

Referring back to FIG. 1, there are additional considerations related to instances where the service provider 106 may incorrectly assess a connected vehicle being in a controlled area. For example, a vehicle may pass through a city defined GPS coordinate zone (e.g., controlled area) but is not using a curb space. The service provider can be configured to differentiate scenarios between instances where the vehicle is using the curb space or just passing through or stopped at a red light or double parked, for example.

The service provider 106 can rely on additional data obtained from, for example, other inputs from on-board vehicle sensors such as a forward facing camera 138. The forward facing camera 138 can capture a screenshot to be included with the time-stamped, location and vehicle data. To protect privacy, this visual data may be processed by an algorithm to identify cues that support one or more regulatory framework(s). Additional data can be obtained from a sensor platform 140 such as gyroscopes, accelerometers, and the like. The connected vehicle 104 can connect to the network 108 using the communications interface 130.

Rather than, or in addition to, relying on a vehicle based camera, the service provider 106 could obtain images from another connected vehicle in the vicinity and/or from an infrastructure camera, such as camera 142 that is located near the controlled area 102.

In another example, the camera 142 could include a thermal imaging camera could be used to assess vehicle occupancy should a city regulate access by that measure. In yet another example, if a city has preinstalled sensors and cameras (say due to proximity to a traffic signal) then inputs from those can be consumed and processed by the system to confirm curb usage.

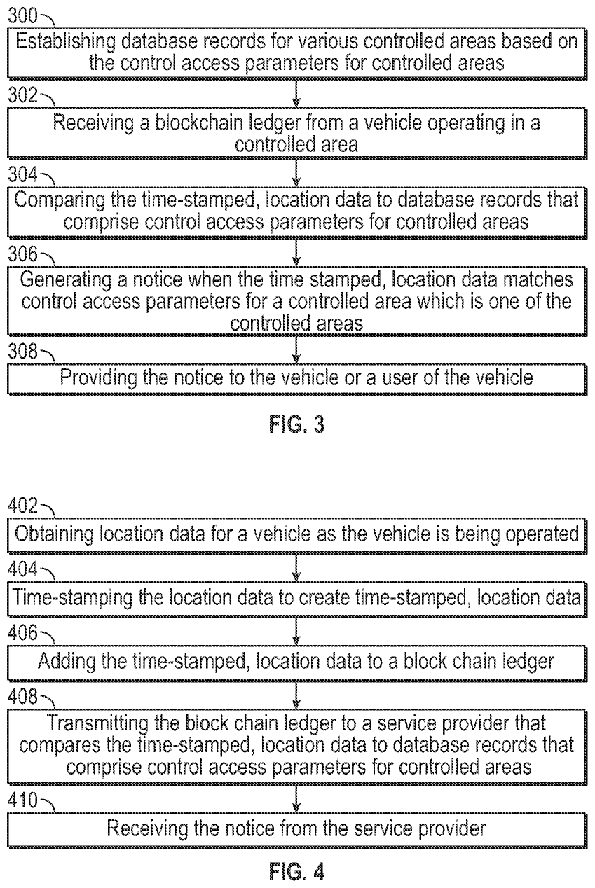

FIG. 3 is a flowchart of an example method that can be performed by a service provider as disclosed herein. The method can include a step 300 of establishing database records for various controlled areas based on the control access parameters for controlled areas. These can be received from an administrator such as a traffic engineer or city planner. The control access parameters can include any one or more of geo-location, timing or usage, and cost, the notice comprising content that is indicative of the control access parameters for the controlled area. The controlled area can include any type of a curb, cordon access, low emission zone, high-occupancy vehicle zone and/or combinations thereof.

The method can include a step 302 of receiving a blockchain ledger from a vehicle operating in a controlled area. As noted above, the blockchain ledger can include time-stamped, location and vehicle data. The blockchain ledger can also include other data gathered from the vehicle such as vehicle operating parameters (speed, direction, etc.), images from cameras or sensors, and/or descriptive vehicle data like a VIN, make, model, and so forth. These data can be used not only to identify where the vehicle has been, but also data that aids in specifically identifying the vehicle and/or differentiating the vehicle from others.

The method can include as step 304 of comparing the time-stamped, location and vehicle data to database records that comprise control access parameters for controlled areas. The service provider can compare the time-stamped, location and vehicle data to the data included in the controlled access database.

The method can include a step 306 of generating a notice when the time-stamped, location and vehicle data matches control access parameters for a controlled area which is one of the controlled areas. In one example, the time-stamped, location and vehicle data is utilized to identify when the vehicle enters or exits the controlled area. It will be understood that if the comparison of time-stamped, location data from the vehicle with controlled areas reveals that the vehicle must pay a fee for its use of the curb, parking spot, and so forth, then the service provider can generate that notice. Next, the method includes a step 308 of providing the notice to the vehicle or a user of the vehicle.

The method can include additional steps related to verifying presence of the vehicle in relation to the controlled area using an image or sensor data. Data used to verify presence of the vehicle can be obtained from any one or more of a forward facing camera of the vehicle, an infrastructure camera located in the controlled area, and/or a camera of another vehicle that is in proximity to the vehicle. In some instance, thermal images obtained from a thermal imaging camera located in the controlled area can be used.

FIG. 4 is another flowchart of an example method that includes a step 402 of obtaining location data for a vehicle as the vehicle is being operated. The vehicle can obtain location data or other ancillary data from an on-vehicle platform such as a reporting module (see above with respect to FIG. 1, namely reporting module 124). The method can also include a step 404 of time-stamping the location data to create time-stamped, location and vehicle data. Any ancillary data can be time-stamped as well. In some embodiments, the method can include a step 406 of adding the time-stamped, location and vehicle data to a blockchain ledger, as well as a step 408 of transmitting the blockchain ledger to a service provider that compares the time-stamped, location and vehicle data to database records that comprise control access parameters for controlled areas. The service provider can generate a notice when the time-stamped, location and vehicle data matches control access parameters for a controlled area which is one of the controlled areas. Next, the method includes a step 410 of receiving the notice from the service provider.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” and the like indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments disclosed herein whether or not explicitly described.

Those skilled in the art will appreciate that the present disclosure may be practiced in network computing environments with many types of computer system configurations, including in vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method, comprising:
receiving a blockchain ledger from a vehicle operating in a controlled area, wherein the blockchain ledger comprises time-stamped, location and vehicle data;
comparing the time-stamped, location and vehicle data to database records that comprise control access parameters related to controlled areas;
generating a notice based on the time-stamped, location and vehicle data matching a control access parameter for a controlled area of the controlled areas;
utilizing the blockchain ledger comprising the time-stamped, location and vehicle data to identify when the vehicle enters or exits the controlled area; and
providing the notice to the vehicle or a user of the vehicle.

2. The method according to claim 1, further comprising establishing the database records for the controlled areas based on the control access parameters received from an administrator.

3. The method according to claim 1, wherein the control access parameters comprise any one or more of geo-location, timing or usage, and cost, the notice comprising content that is indicative of the control access parameters for the controlled area.

4. The method according to claim 1, further comprising verifying presence of the vehicle in relation to the controlled area using an image obtained from any one or more of:
a forward facing camera of the vehicle;
an infrastructure camera located in the controlled area; and/or
a camera of another vehicle that is in proximity to the vehicle.

5. The method according to claim 1, further comprising verifying presence of the vehicle in relation to the controlled area and vehicle occupancy using thermal image obtained from a thermal imaging camera located in the controlled area or associated with the vehicle.

6. (canceled)

7. The method according to claim 1, wherein the controlled area includes any of a curb, cordon access, low emission zone, high-occupancy vehicle zone and/or combinations thereof.

8. The method according to claim 1, further comprising generating a vehicle record for the vehicle that includes a vehicle identification number (VIN), wherein the VIN is further added to the blockchain ledger.

9. A method, comprising:
obtaining location data for a vehicle as the vehicle is being operated;
time-stamping the location data to create time-stamped, location and vehicle data;
adding the time-stamped, location and vehicle data to a blockchain ledger;
transmitting the blockchain ledger to a service provider that compares the time-stamped, location and vehicle data to database records that comprise control access parameters for controlled areas and generates a notice when the time-stamped, location and vehicle data matches a control access parameter for a controlled area of the controlled areas;
utilizing the blockchain ledger comprising the time-stamped, location and vehicle data to identify when the vehicle enters or exits the controlled area; and
receiving, at the vehicle, the notice from the service provider.

10. The method according to claim 9, further comprising providing data for a vehicle record for the vehicle that includes a vehicle identification number (VIN), wherein the VIN is further added to the blockchain ledger.

11. The method according to claim 9, further comprising receiving, from an administrator, the control access parameters and creating the database records for the controlled areas based on the control access parameters.

12. The method according to claim 9, wherein the control access parameters comprise any one or more of geo-location, timing or usage, and cost, the notice comprising content that is indicative of the control access parameters for the controlled area.

13. The method according to claim 9, wherein the service provider is configured to verify presence of the vehicle in relation to the controlled area using an image obtained from any one or more of:
a forward facing camera of the vehicle;
an infrastructure camera located in the controlled area; and/or
a camera of another vehicle that is in proximity to the vehicle.

14. The method according to claim 9, wherein the service provider is configured to verify presence of the vehicle in relation to the controlled area and vehicle occupancy using thermal image obtained from a thermal imaging camera located in the controlled area.

15. (canceled)

16. The method according to claim 9, wherein the controlled area includes any of a curb, cordon access, low emission zone, high-occupancy vehicle zone and/or combinations thereof.

17. A system, comprising:
a processor; and
a memory for storing instructions, the processor being configured to execute the instructions to:
receive a blockchain ledger from a vehicle operating in a controlled area, the blockchain ledger comprising time-stamped, location and vehicle data;
compare the time-stamped, location and vehicle data to database records that comprise control access parameters for controlled areas;
generate a notice when the time-stamped, location and vehicle data matches a control access parameter for a controlled area of the controlled areas;
utilize the blockchain ledger comprising the time-stamped, location and vehicle data to identify when the vehicle enters or exits the controlled area; and
provide the notice to the vehicle or a user of the vehicle.

18. The system according to claim 17, wherein the processor is configured to establish the database records for the controlled areas based on the control access parameters that have been received from an administrator.

19. The system according to claim 17, wherein the control access parameters comprise any one or more of geo-location, timing or usage, and cost, the notice comprising content that is indicative of the control access parameters for the controlled area.

20. The system according to claim 17, wherein the processor is configured to verify presence of the vehicle in relation to the controlled area using an image obtained from any one or more of:
a forward facing camera of the vehicle;
an infrastructure camera located in the controlled area; and/or
a camera of another vehicle that is in proximity to the vehicle.

21. The method according to claim 1, further comprising:
determining that the vehicle has entered the controlled area and is using the controlled area; and
generating, responsive to the determination that the vehicle has entered the controlled area and is using the controlled area, the notice based on the time-stamped, location and vehicle data matching the control access parameter for the controlled area.

22. The method according to claim 9, further comprising:
determining that the vehicle has entered the controlled area and is using the controlled area; and
generating, responsive to the determination that the vehicle has entered the controlled area and is using the controlled area, the notice based on the time-stamped, location and vehicle data matching the control access parameter for the controlled area.
